(19) United States
(12) Patent Application Publication
(10) Pub. No.: US 2026/0209595 A1
(43) Pub. Date: Jul. 23, 2026

(54) METHODS, SYSTEMS, AND COMPOSITIONS FOR IN-SITU FOAM GENERATION FOR LIQUID UNLOADING

(71) Applicant: SAUDI ARABIAN OIL COMPANY, Dhahran (SA)

(72) Inventors: Sharefah A. ALSULTAN, Dhahran (SA); Prasad B. KARADKAR, Dhahran (SA); Bader G. ALHARBI, Dhahran (SA)

(73) Assignee: SAUDI ARABIAN OIL COMPANY, Dhahran (SA)

(21) Appl. No.: 19/035,273

(22) Filed: Jan. 23, 2025

(51) Int. Cl. C09K 8/594; C09K 8/584; C09K 8/588; E21B 43/16

(52) U.S. Cl. CPC C09K 8/594; C09K 8/584; C09K 8/588; E21B 43/168

(57) ABSTRACT

Methods for unloading accumulated liquids from a wellbore may comprise: providing a plurality of encapsulated foam generating agents comprising a gas-producing agent; a foam stabilizer; a foaming agent; an optional internal coating material; an external coating material; and placing the encapsulated foam generating agents into a wellbore, the wellbore having accumulated liquids; allowing a foam to generate in the wellbore through decomposition of the coating materials of the encapsulating foam generating agents; and unloading at least some of the accumulated liquids from the wellbore through recovery of the foam. Systems for unloading accumulated liquids from a wellbore may comprise the foregoing encapsulated foam generating agents and stimulating device configured to stimulate the encapsulated foam generating agent.

### FIELD

The present disclosure generally relates to methods, systems, and compositions for addressing liquid accumulation in wells, and more particularly, relates to novel methodology for generating in-situ foam to reduce hydrostatic pressure and/or unload liquid accumulation in wellbores.

### BACKGROUND

Liquid accumulation in oil and gas wells is a significant operational concern, impacting both the efficiency and safety of extraction processes. Over time, various liquids, including formation water and hydrocarbons, can accumulate at the bottom of a well. This build-up can create hydrostatic pressure that counteracts the pressure exerted by the reservoir, thereby impeding the natural flow of oil or gas to the surface. If not properly managed, liquid accumulation can lead to decreased production rates (or dead wells), increased operational costs, and potential damage to the well infrastructure.

Known methods for unloading liquid accumulation from wellbores include dropping soap sticks into gas wells, artificial lifting techniques, gas lifting techniques, pump-assisted lifting, and coiled tubing operations using nitrogen that release gas to lift liquid accumulation. All these wellbore intervention methods are time consuming and expensive. As such, there is a desire for better methods to unload liquid accumulations from wellbores.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more aspects, the present disclosure provides methods for unloading accumulated liquids from a wellbore comprising: providing a plurality of encapsulated foam generating agents comprising a gas-producing agent; a foam stabilizer; a foaming agent; an optional internal coating material; an external coating material; and placing the encapsulated foam generating agents into a wellbore, the wellbore having accumulated liquids; allowing a foam to generate in the wellbore through decomposition of the coating materials of the encapsulating foam generating agents; and unloading at least some of the accumulated liquids from the wellbore through recovery of the foam.

In one or more aspects, the present disclosure provides systems for unloading liquids from a wellbore comprising: a plurality of encapsulated foam generating agents comprising a gas-producing agent; a foam stabilizer; a foaming agent; a coating material; and a stimulating device configured to stimulate the encapsulated foam generating agent.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 shows an example configuration of an encapsulated foam generating agent.

FIG. 2 shows an example of a method of using an encapsulated foam generating agent.

FIG. 3 shows an example of a method of using an encapsulated foam generating agent to release gas in the wellbore.

FIG. 4 shows foam testing results for formation water foams.

FIG. 5 shows the results of foam testing by foaming agent concentration.

FIG. 6 shows the foam testing results for gas condensate foams.

### DETAILED DESCRIPTION

The present disclosure generally relates to methods, systems, and compositions for addressing liquid accumulation in wells, and more particularly, relates to novel methodology for generating in-situ foam to reduce hydrostatic pressure and or unload liquid accumulation in wellbores. The term “accumulated liquids” and its derivatives as used herein refers to waters, such as formation waters, gas condensates, and the like that accumulate in wellbores, e.g., when there is no flow of gas in the well or the well is a dead well. An advantage of the methods and systems of the present disclosure is that the encapsulated foam generating agents can produce both foam and gas to unload accumulated liquids from the wellbore. A further advantage is that the encapsulated foam generating agents can be placed into a wellbore and subsequently a stimuli can be applied to cause the encapsulated foam generating agents to produce foam and gas. This provides a simple and inexpensive way to unload accumulated liquids from a wellbore.

The present disclosure provides methods for unloading accumulated liquids from a wellbore comprising: providing a plurality of encapsulated foam generating agents comprising a gas-producing agent; a foam stabilizer; a foaming agent; an optional internal coating material; an external coating material; and placing the encapsulated foam generating agents into a wellbore, the wellbore having accumulated liquids; allowing a foam to generate in the wellbore through decomposition of the coating materials of the encapsulating foam generating agents; and unloading at least some of the accumulated liquids from the wellbore through recovery of the foam. The term “unloading” and its derivatives as used herein refers to the process of removing accumulated liquids, such as water or condensate, from the wellbore to restore or enhance the flow of gas and/or liquids.

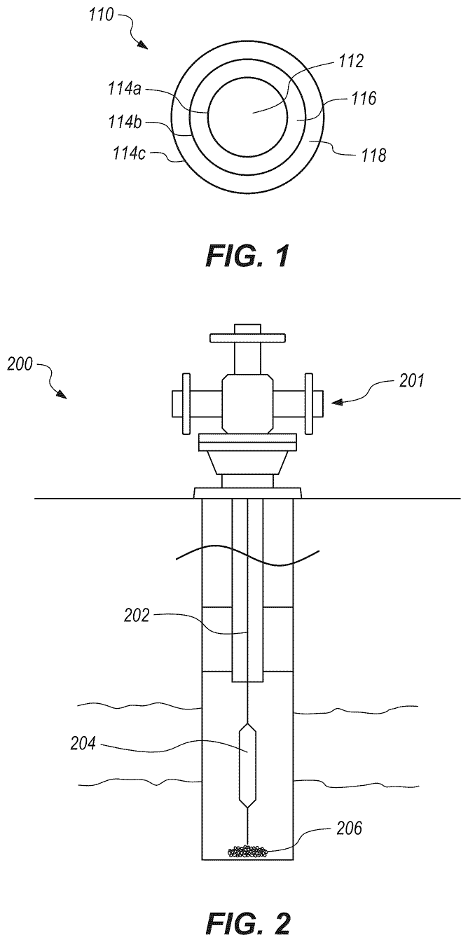

The coating material can encapsulate the various layers of the encapsulated foam generating agents as shown in FIG. 1. Shown in FIG. 1 is encapsulated foam generating agent 110. Encapsulated foam generating agents may include gas-producing agent 112 which may be surrounded by an internal coating material layer 114a, which is then surrounded by a foam stabilizer layer 116, which itself may be surrounded by a second internal coating material layer 114b, and a foaming agent layer 118, which is surrounded by an external coating material layer 114c. Gas-producing agent 112 may comprise about 0.1 weight percent (wt %) to about 70 wt % of encapsulated foam generating agent 110, based on the total weight of encapsulated foam generating agent 110, including all values and subsets therebetween, including from about 1 wt % to about 40 wt % or about 1 wt % to about 2 wt %. Foam stabilizer layer 116 may comprise about 0.1 wt % to about 40 wt % of encapsulated foam generating agent 110, based on the total weight of encapsulated foam generating agent 110, including all values and subsets therebetween, including from about 0.1 wt % to about 0.2 wt % or about 1 wt % to about 40 wt %. Foaming agent layer 118 may comprise about 1 wt % to about 60 wt % of encapsulated foam generating agent 110, based on the total weight of the encapsulated foam generating agent, including all values and subsets therebetween, including from about 0.01 wt % to about 2 wt % or about 1 wt % to about 40 wt %. External coating material layer 114c may comprise about 0.01 wt % to about 90 wt % of encapsulated foam generating agent 110, based on the total weight of the encapsulated foam generating agent, including all values and subsets therebetween, including from about 1 wt % to about 10 wt % or about 1 wt % to about 50 wt %. Each of internal coating material layer 114a and 114b may comprise the same or different amounts of encapsulated foam generating agent 110.

The coating material (at any layer in the encapsulated foam generating agents) may decompose or disassociate (e.g., when exposed to a stimulus or through degradation via hydrolysis) so as to release the components of the encapsulated foam generating agents into the accumulated liquids in the wellbore. Upon exposure, the encapsulated foam generating agents react to generate foam and gas. The foam and gas unloads the liquid from the wellbore. This is believed to reduce the hydrostatic pressure in the wellbore, thereby allowing desirable fluids such as natural gas to flow to the wellbore for production.

Relative to the encapsulated foam generating agents (e.g., FIG. 1), gas-producing agents may include those that are capable of being encapsulated by a coating material and can produce gas. Suitable gas-producing agents may include compounds that react or disassociate when contacted with water or gas condensate to produce gas, including compounds that react or disassociate to produce nitrogen, oxygen, carbon dioxide, carbon monoxide, the like, or combinations thereof. Examples may include azide compounds, metal azide compounds, ammonium azide, alkali and alkali earth azides, sodium azide, bicarbonate compounds, metal carbonates, ammonium carbonates, nitrate compounds, metal nitrates, peroxide compounds, metal peroxides, oxo halide compounds, hypochlorite compounds, calcium hypochlorite, the like, and combinations thereof. A particularly useful example may be sodium azide.

Suitable foam stabilizers for use in the encapsulated foam generating agents of this disclosure may include materials that prevent or delay coalescence or rupture of foam bubbles. Examples may include viscoelastic fluids, gelling agents, polymers, gums, starches, cellulose polymers, polyethylene glycol, xanthan gum, guar gums, polyacrylamides, polyvinyl alcohols, polyethylene oxides, colloidal nanosilicas, surface modified nanoparticles, surface modified nanosilicas, surface modified metal oxide particles, surface modified iron oxide particles, and surface modified nanoparticles modified with silanes, organosilanes, 3-aminopropyltriethoxysilane (APTES), carboxylates, amines, phosphonates, thiols, polymers, polyethylene glycols, or octadecyl, the like, and combinations thereof.

Suitable foaming agents for use in the encapsulated foam generating agents of this disclosure include anionic, cationic, nonionic, and amphoteric/zwitterionic surfactants. Example nonionic surfactants may include alkoxylated alcohols or ethers, alkyl ethoxylates, alkylamido ethoxylates, the like, and combinations thereof. Example cationic surfactants may include quaternary ammonium compounds, monoalkyl quaternary amines, cetyltrimonium chloride, cetrimonium halides, cetrimonium bromide, dialkyl quaternary amines, dicocodimethyl ammonium chloride, the like, and combinations thereof. Example anionic surfactants may include fatty carboxylates, alkyl phosphates, alkyl sulfonates, alkyl sulfates, sodium dodecyl sulfate, alkyl ether sulfates, alkyl phosphate esters, the like, and combinations thereof. Example amphoteric/zwitterionic surfactants may include betaines, alkyl betaines, alkylamido betaines, sulfobetaines, phosphobetaines, the like, and combinations thereof.

Suitable coating materials for use in the encapsulated foam generating agents of this disclosure may include coating materials that coat one or more components of the encapsulated foam generating agent and are partially or wholly resistant to reaction or disassociation in water, hydrocarbons, gas condensate, the like, and combinations thereof. Suitable coating materials may be wholly resistant to water, hydrocarbons, and/or gas condensate and the encapsulated material may not react, dissolve, or disassociate until a stimulus is applied to it. Stimuli may include introducing a compound that is reactive with the coating material, presence of a particular solvent, heat, pH change, electrical stimuli, magnetic stimuli, microwave stimuli, the like, and combinations thereof. Suitable coating materials may include water-soluble or gas-condensate soluble coatings. Example coating materials may include pH-sensitive coatings, temperature-sensitive coatings, solvent-sensitive coatings, polymers, polyvinyl alcohol, polyethylene glycol, polylactic acid, polyurethane, polyolefins, polyethylene, polypropylene, polystyrene, polyurea, urea-formaldehyde polymers, EPDM rubber, polyvinylidene chloride, nylon, polyacrylics, polyethylene glycols, polyacrylamides, gums, starches, pectin, chitosan, hydroxyethyl starch, carboxylmethyl cellulose, methylcellulose, gum arabic, carrageenan, xanthan, polyethylene oxide, polypropylene oxide, polyalkylene glycol diacrylates, copolymers thereof, inorganic materials, ceramics, the like, and combinations thereof.

The coating materials may be crosslinked with crosslinking agents. Suitable crosslinking agents may include materials that crosslink polymeric materials either chemically, by way of covalent bonding, or physically, by way of the formation of a complex. Suitable crosslinkers may include compounds that contain two or more reactive sites that bind with the coating material. Example crosslinking agents may include melamine-formaldehyde and urea-formaldehyde crosslinkers, hexamethoxymethylmelamine, epoxy crosslinkers, isocyanate crosslinkers, acrylic crosslinkers, peroxide crosslinkers, metals divalent ions, trivalent ions, borates, the like, and combinations thereof. The crosslinking agent may be present in the encapsulated foam generating agent in an amount of about 0.01 wt % to about 10 wt %, based on the total weight of the encapsulated foam generating agent, including all values and subsets therebetween, including from about 0.01 wt % to about 0.02 wt %, about 0.01 wt % to about 2 wt %, or about 2 wt % to about 5 wt %.

The encapsulated foam generating agents of this disclosure may be placed into a wellbore that has at least some liquid accumulation. The accumulated liquids may include hydrocarbons, gas condensate, formation waters, the like, and combinations thereof. The encapsulated foam generating agents may be placed into a wellbore by any known means for placing materials into wellbores. In one or more embodiments, encapsulated foam generating agents may be placed into the wellbore by pumping encapsulated foam generating agent fluids into the wellbore. In one or more embodiments, encapsulated foam generating agents may be placed into the wellbore by inserting them from the top of the wellbore whereby they descend into the wellbore via gravity. In one or more embodiments, encapsulated foam generating agents may be placed into the wellbore by pumping encapsulated foam generating agent fluids into the wellbore. The encapsulated foam generating agent fluid may include encapsulated foam generating agents and carrier fluids. Suitable carrier fluids include aqueous fluids, produced water, brine, oleaginous fluids, hydrocarbons, naturally derived oils, synthetically derived oils, mineral oils, diesel oils, the like, combinations thereof, or other fluids capable of transporting encapsulated foam generating agents into a wellbore. The encapsulated foam generating agents may be present in the encapsulated foam generating agent fluid in an amount of about 1 wt % to about 95 wt %, based on the total weight of the encapsulated foam generating agent fluid, including all values and subsets therebetween, including from about 1 wt % to about 50 wt %, about 10 wt % to about 30 wt %, or about 30 wt % to about 80 wt %.

In one or more embodiments, after the encapsulated foam generating agents have been placed into the wellbore the external coating layer of the encapsulated foam generating agents of this disclosure may be allowed to decompose when exposed to hydrocarbons, gas condensate, water, the like, or combinations thereof (e.g., through hydrolysis).

In one or more embodiments, after being placed into the wellbore the external coating of the encapsulated foam generating agents of this disclosure may be actively stimulated to decompose, for example, through the use of a heat source. Heating the external coating layer creates an exothermic reaction releasing the components of the encapsulated foam generating agents. Suitable heat sources include, but are not limited to, shining a laser device on the encapsulated foam generating agents when they are in the desired location of the wellbore. In an example, an electrical spark may be used as the heat source. In another example, microwave radiation may be used as the heat source. Combinations of these heat sources or other heat sources known as suitable to use in a wellbore environment by those skilled in the art may also be used.

Upon decomposition of the external coating layer (and internal coating layers if used), the foaming agents, foam stabilizers, and gas-producing agents react to create a foam that unloads the liquid accumulation in the well.

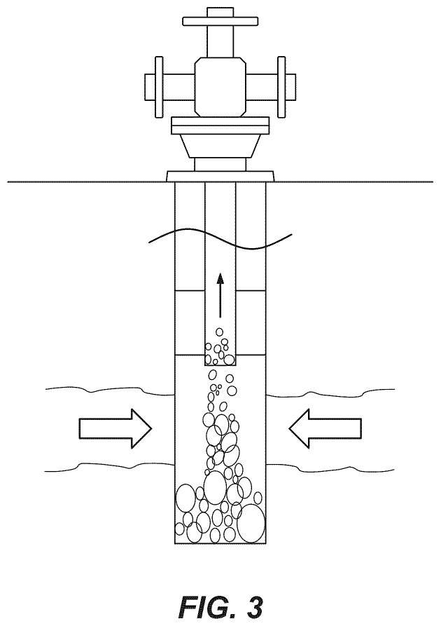

Referring to the Figures, FIG. 2 shows a wellbore and an example system 200 for unloading liquid from a wellbore. The wellbore has a wellhead 201. System 200 may include cable 202. Cable 202 is connected to stimulating device 204. Cable 202 may be used to position stimulating device 204 in the wellbore. Stimulating device 204 may be used to communicate a stimuli to a plurality of encapsulated foam generating agent 206. Stimulating device 204 may be any means to create a stimuli, for example, a laser, a heater, a downhole electric spark generator, a downhole microwave energy generator, any combination thereof, or any other device known to produce a heat source safely downhole. The stimuli should partially or wholly react or disassociate the encapsulated foam generating agents so as to release the components of the encapsulated foam generating agents into the accumulated liquids in the wellbore, which will allow the foaming agent, foam stabilizer, and gas-producing agent to form foam and gas which can unload the accumulated liquids from the wellbore. FIG. 3 illustrates how the accumulated liquids are transformed into foam allowing the bottomhole pressure to decrease as it unloads the accumulated liquids. The foam can then be recovered at the surface and disposed of as desired.

The present disclosure is further directed to the following non-limiting clauses:
Clause 1: A method for unloading accumulated liquids from a wellbore comprising: providing a plurality of encapsulated foam generating agents comprising a gas-producing agent; a foam stabilizer; a foaming agent; an optional internal coating material; an external coating material; and placing the encapsulated foam generating agents into a wellbore, the wellbore having accumulated liquids; allowing a foam to generate in the wellbore through decomposition of the coating materials of the encapsulating foam generating agents; and unloading at least some of the accumulated liquids from the wellbore through recovery of the foam.
Clause 2: The method of clause 1, further comprising recovering a hydrocarbon gas from the wellbore.
Clause 3: The method of any of clauses 1 or 2, wherein the encapsulated foam generating agents decompose when exposed to at least one of hydrocarbons, gas condensate, and water.
Clause 4: The method of any of clauses 1-3, further comprising decomposing the external coating material of the plurality of encapsulated foam generating agents in the well.
Clause 5: The method of any of clauses 1-4, wherein decomposing comprises at least one of heating the encapsulated foam generating agents, creating an exothermic reaction to heat the encapsulated foam generating agents, shining a laser device on the encapsulated foam generating agents, applying an electrical spark to the encapsulated foam generating agents, and applying microwave radiation to the encapsulated foam generating agents.
Clause 6: The method of any of clauses 1-5, wherein the gas-producing agent is present in the encapsulated foam generating agents in an amount of about 1 weight percent (wt %) to about 70 wt %, based on the total weight of the encapsulated foam generating agents.
Clause 7: The method of any of clauses 1-6, wherein the foam stabilizer is present in the encapsulated foam generating agents in an amount of about 0.1 wt % to about 40 wt %, based on the total weight of the encapsulated foam generating agents.
Clause 8: The method of any of clauses 1-7, wherein the foaming agent is present in the encapsulated foam generating agents in an amount of about 0.1 wt % to about 60 wt %, based on the total weight of the encapsulated foam generating agents.
Clause 9: The method of any of clauses 1-8, wherein the external coating material is present in the encapsulated foam generating agents in an amount of about 0.1 wt % to about 90 wt %, based on the total weight of the encapsulated foam generating agents.
Clause 10: The method of any of clauses 1-9, wherein the gas-producing agent comprises at least one of a metal azide and sodium azide.
Clause 11: The method of any of clauses 1-10, wherein the foam stabilizer comprises surface modified nanoparticles comprising at least one of a silane group, carboxylate group, amine, 3-aminopropyltriethoxysilane, polyethyelene glycol, and octadecyl.
Clause 12: The method of any of clauses 1-11, wherein the foaming agent comprises at least one of a quaternary ammonium compound, betaine, cetrimonium halide, and sodium dodecyl sulfate.
Clause 13: The method of any of clauses 1-12, wherein the external coating material comprises at least one of polyvinyl alcohol, polyurethane, polyethylene, and polylactic acid.
Clause 14: A system for unloading liquid from a wellbore comprising: a plurality of encapsulated foam generating agents comprising a gas-producing agent; a foam stabilizer; a foaming agent; a coating material; and a stimulating device configured to stimulate the encapsulated foam generating agent.
Clause 15: The system of clause 14, wherein the stimulation performed by the stimulating device comprises at least one of heating the encapsulated foam generating agents, shining a laser device on the encapsulated foam generating agents, applying an electrical spark to the encapsulated foam generating agents, and applying microwave radiation to the encapsulated foam generating agents.
Clause 16: The system of any of clauses 14-15, wherein the gas-producing agent comprises at least one of a metal azide and sodium azide.
Clause 17: The system of any of clauses 14-16, wherein the foam stabilizer comprises surface modified nanoparticles comprising at least one of a silane group, carboxylate group, amine, 3-aminopropyltriethoxysilane, polyethyelene glycol, and octadecyl.
Clause 18: The system of any of clauses 14-17, wherein the foaming agent comprises at least one of a quaternary ammonium compound, betaine, cetrimonium halide, and sodium dodecyl sulfate.
Clause 19: The system of any of clauses 14-18, wherein the external coating material comprises at least one of polyvinyl alcohol, polyurethane, polyethylene, and polylactic acid.
Clause 20: The system of any of clauses 14-19, wherein the gas-producing agent is present in the encapsulated foam generating agent in an amount of about 1 weight percent (wt %) to about 70 wt %, based on the total weight of the encapsulated foam generating agent.

### Examples

To facilitate a better understanding of the embodiments of the present disclosure, the following examples of preferred or representative embodiments are given. In no way should the following examples be read to limit, or to define, the scope of the invention.

The foaming agent was evaluated for foam performance. The foaming agent tested was Marfoam® CAB (Solvay). The foaming agent was mixed with synthetic formation water at 0.5 vol %, 0.75 vol %, and 1.0 vol % and injected with nitrogen gas to create foams. The formation water was prepared by dissolving the below salts into deionized water. The formation water had the below concentration of ions. The foams were formed in liquid columns to measure each foam's half-life.

TABLE 1

| Ions | Concentration (ppm) |
|---|---|
| Sodium | 52100 |
| Calcium | 7800 |
| Magnesium | 622 |
| Chloride | 95600 |
| Bicarbonate | 179 |
| Sulfate | 344 |
| Total dissolved solids | 156,645 |

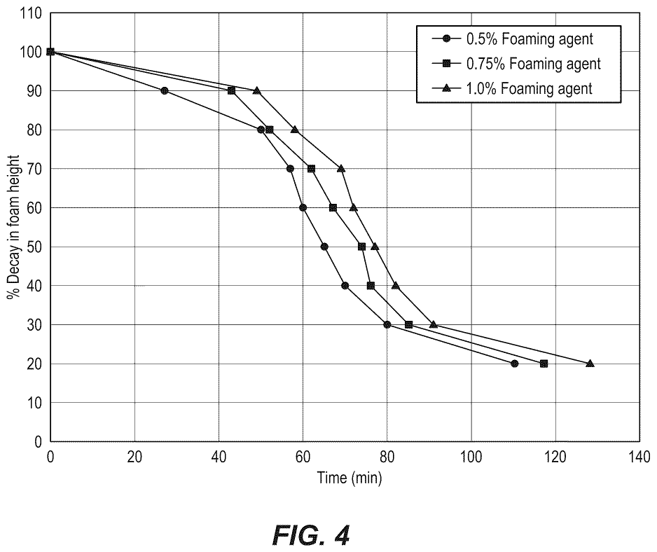

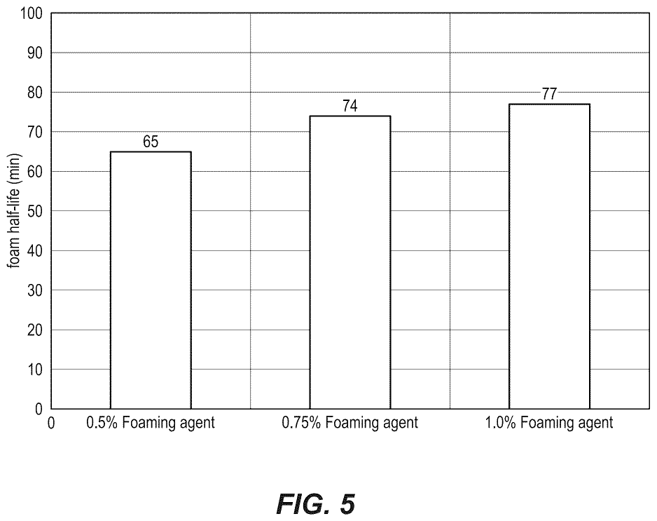

FIG. 4 shows the foam height decay as a function of time for foam formulations with varying amounts of foaming agent. FIG. 4 shows that formulations with a higher concentration of foaming agent had a delay in the decline of foam stability. FIG. 4 shows the foam half-life for the foam formulations. FIG. 5 shows that with a higher concentration of foaming agent, the foam half-life increased.

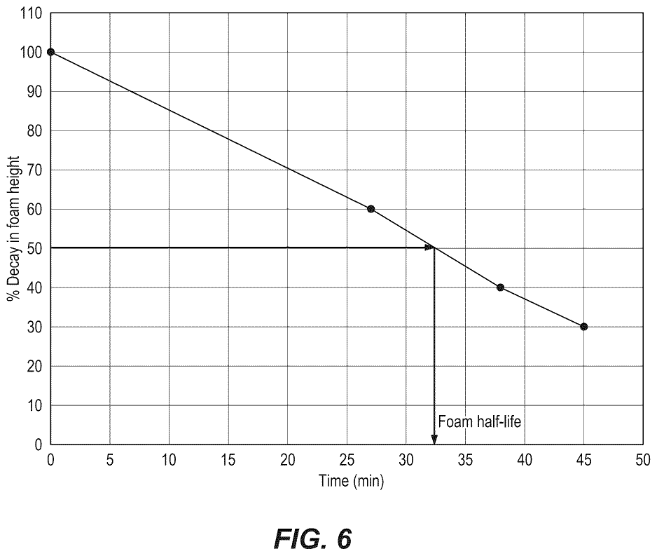

Static foam stability using a fluoro-polymeric foaming agent was mixed with gas condensate and was tested to investigate foamability. The fluoro-polymeric foaming agent was mixed at 0.5 vol % with gas condensate and injected with nitrogen gas to create a foam. FIG. 6 shows the foam decay in percent with respect to time. The foam's half-life was measured to be 32.5 minutes, showing foam stability with gas condensate.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A method for unloading accumulated liquids from a wellbore comprising:
providing a plurality of encapsulated foam generating agents comprising
a gas-producing agent;
a foam stabilizer;
a foaming agent;
an optional internal coating material;
an external coating material;
wherein the gas-producing agent, the foam stabilizer, and the foaming agent each define circular layers surrounded by a circular layer of the external coating material; and
placing the encapsulated foam generating agents into a wellbore, the wellbore having accumulated liquids;
generating a foam in the wellbore through decomposition of the coating materials of the encapsulating foam generating agents; and
unloading at least some of the accumulated liquids from the wellbore through recovery of the foam.

2. The method of claim 1, further comprising recovering a hydrocarbon gas from the wellbore.

3. The method of claim 1, wherein the encapsulated foam generating agents decompose when exposed to at least one of hydrocarbons, gas condensate, and water.

4. The method of claim 1, further comprising decomposing the external coating material of the plurality of encapsulated foam generating agents in the well.

5. The method of claim 1, further comprising positioning a stimulating device in the wellbore, the stimulating device having a first end attached to a cable and a second end having a means for creating a stimulus, and wherein decomposing comprises stimulating, via the means for creating a stimulus, by at least one of heating the encapsulated foam generating agents, creating an exothermic reaction to heat the encapsulated foam generating agents, shining a laser device on the encapsulated foam generating agents, applying an electrical spark to the encapsulated foam generating agents, and applying microwave radiation to the encapsulated foam generating agents.

6. The method of claim 1, wherein the gas-producing agent is present in the encapsulated foam generating agents in an amount of about 1 weight percent (wt %) to about 70 wt %, based on the total weight of the encapsulated foam generating agents.

7. The method of claim 1, wherein the foam stabilizer is present in the encapsulated foam generating agents in an amount of about 0.1 wt % to about 40 wt %, based on the total weight of the encapsulated foam generating agents.

8. The method of claim 1, wherein the gas-producing agent defines a core, the foam stabilizer defines a layer surrounding the gas-producing agent, and the foaming agent defines a layer surrounding the foam stabilizer.

9. The method of claim 1, wherein the external coating material is present in the encapsulated foam generating agents in an amount of about 0.1 wt % to about 90 wt %, based on the total weight of the encapsulated foam generating agents.

10. The method of claim 1, wherein the gas-producing agent comprises a metal azide.

11. The method of claim 1, wherein the foam stabilizer comprises surface modified nanoparticles comprising at least one of a silane group, carboxylate group, amine, 3-aminopropyltriethoxysilane, polyethyelene glycol, and octadecyl.

12. The method of claim 1, wherein the foaming agent comprises at least one of a quaternary ammonium compound, betaine, cetrimonium halide, and sodium dodecyl sulfate.

13. The method of claim 1, wherein the external coating material comprises at least one of polyvinyl alcohol, polyurethane, polyethylene, and polylactic acid.

14. A system for unloading liquid from a wellbore comprising:
a plurality of encapsulated foam generating agents comprising
a gas-producing agent;
a foam stabilizer;
a foaming agent;
a coating material; and
a stimulating device configured to stimulate the encapsulated foam generating agent, the stimulating device having a first end attachable to a cable and a second end having a means for creating a stimulus.

15. The system of claim 14, wherein the stimulation performed by the stimulating device comprises at least one of heating the encapsulated foam generating agents, applying an electrical spark to the encapsulated foam generating agents, and applying microwave radiation to the encapsulated foam generating agents.

16. The system of claim 14, wherein the gas-producing agent comprises a metal azide.

17. The system of claim 14, wherein the foam stabilizer comprises surface modified nanoparticles comprising at least one of a silane group, carboxylate group, amine, 3-aminopropyltriethoxysilane, polyethyelene glycol, and octadecyl.

18. The system of claim 14, wherein the foaming agent comprises at least one of a quaternary ammonium compound, betaine, cetrimonium halide, and sodium dodecyl sulfate.

19. The system of claim 14, wherein the external coating material comprises at least one of polyvinyl alcohol, polyurethane, polyethylene, and polylactic acid.

20. The system of claim 14, wherein the stimulation device is attached to a cable, positioned in a wellbore by the cable, and the plurality of encapsulated foam generating agents are positioned in the wellbore to be stimulated by the stimulation device.
